(19) United States
(12) Patent Application Publication
(10) Pub. No.: US 2007/0247741 A1
(43) Pub. Date: Oct. 25, 2007

(54) Method of servo pattern writing on recording surface and data storage device

(75) Inventors: Kyo Akagi, Tokyo (JP); Takehiko Hamaguchi, Kanagawa (JP); Atsushi Takeichi, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/788,490

(22) Filed: Apr. 20, 2007

(30) Foreign Application Priority Data
Apr. 20, 2006 (JP) 2006-117047

(51) Int. Cl. G11B 21/02; G11B 5/596

(52) U.S. Cl. 360/75; 360/77.08

(57) ABSTRACT

In an embodiment of the present invention, with Self Servo Write (SSW), a head slider is used to perform AC erase to a recording surface of a magnetic disk. The AC erase is performed asynchronously to every track. A frequency for use with AC erase, i.e., a frequency of an AC erase pattern is three times or higher than a burst frequency of a product servo pattern or a burst frequency of a radial pattern. By satisfying such requirements, for the magnetic disk of vertical magnetic recording, it becomes possible to substantially stop adversely affecting pattern reading in an AC erase area.

### CROSS-REFERENCE TO RELATED APPLICATION

The instant nonprovisional patent application claims priority to Japanese Patent Application 2006-117047, filed Apr. 20, 2006 and incorporated by reference in its entirety herein for all purposes.

### BACKGROUND OF THE INVENTION

Devices using various types of media such as optical discs, magnetic optical discs, and flexible magnetic disk are known in the art as data storage devices. Among these, a hard disk drive (HDD) has become widespread as a storage device for a computer, and is counted as a storage device that is essential for the current computer system. The computer system is not the only possibility, and the range of uses of the HDD is expanding with its superior characteristics, including a removable memory for use with a moving image recording/reproducing device, a vehicle navigation system, a mobile phone, a digital camera, and others.

A magnetic disk for use with an HDD is provided with a plurality of data tracks that are concentrically formed, and a servo track. The servo track includes a plurality of servo data (servo patterns), each with a space in the circumferential direction. Between the servo sectors, user data is recorded. A head element section serving as a thin-film element makes access to any desired area (address) in accordance with the servo data so that the user data can be written or the user data can be read.

The servo patterns (in the specification, these are referred to as product servo patterns) are each configured by a cylinder ID, a sector number, a burst pattern, and others. The cylinder ID indicates an address of a track, and the sector number indicates a sector address in the track. The burst pattern includes information about the relative position of a magnetic head with respect to the track.

As described above, the product servo pattern is formed for a plurality of sectors, each with a space in the corresponding track in the circumferential direction. The product servo patterns positioned at the same position in the circumferential direction, i.e., sharing the same sector number, are aligned in position (phase) in the circumferential direction across every track. The product servo patterns are written to magnetic disks in production facilities before products of HDDs are shipped. Writing of the conventional typical product servo patterns is performed using a servo writer being an external device. An HDD is loaded to the servo writer, a servo track writer positions a head in the HDD using a positioner (external positioning mechanism), and a product servo pattern generated by a product servo pattern generation circuit is written to a magnetic disk.

Currently, a product servo pattern writing process (hereinafter, servo write process) occupies a key position in the manufacturing cost of the HDD. Especially, because the current competition for larger capacity is becoming increasingly fierce, the TPI (Track Per Inch) is increased in the HDD. With the higher TPI, the number of tracks is increased, and the track width (track pitch) is decreased. These are causing the increase of the cost for servo write because the servo write time is increased, and the degree of precision is increased for the servo writer. For the aim of reducing the cost, attempts are made for reducing the cost of the servo writer, for reducing the servo write time, and others.

As a technique for solving the above-described problems, SSW (Self Servo Write) has been proposed. Unlike the conventional servo write, with the SSW, control is exercised over a spindle motor (SPM) and a voice coil motor (VCM) in the HDD from an external circuit using only the mechanical mechanism of the HDD body, and a product servo pattern is written using the external circuit. In this manner, the cost is aimed to be reduced for the servo writer.

With the SSW, utilizing the fact that the read element and the write element of the head element section are positioned at each different position in the radius direction (in this specification, referred to as read/write offset), the head element section is positioned while the read element is reading a pattern already written to the inner radius side or the outer radius side, and the write element writes any new pattern to a desired track with a space of read/write offset. With the SSW, in addition to a product servo pattern, the remaining patterns are written on the recording surface, and with these utilized, control is exercised over the head position and the timing.

Typically, the HDD includes a plurality of recording surfaces, a plurality of head element sections respectively corresponding to the recording surfaces, and an actuator that supports the element sections. With the SSW, using any one head element section (in this specification, referred to as propagation head) selected from the head element sections, pattern reading is made from the recording surfaces, and using a signal of any read pattern, the actuator is controlled. In this manner, a plurality of head element sections are positioned. In the state with such positioning, every head element section simultaneously performs pattern writing to the respective recording surfaces.

On the other hand, for the HDD, increasing the data storage capacity is counted as one important improvement target. As a technology of increasing the recording density of a magnetic disk, vertical magnetic recording is proposed. With the vertical magnetic recording, the recording magnetization is directed vertical with respect to the recording surface for recording. Unlike the horizontal magnetic recording with which the recording magnetization is directed parallel to the recording surface, with the vertical magnetic recording, the demagnetization field by any adjacent magnetic domain is reduced as the recording density is increased. This thus enables to implement the high recording stability with the high recording density.

With the vertical magnetic recording, however, it is known that a DC erase area (DC magnetized area) on a recording surface adversely affects data reading by the read element. The magnetic field of the DC erase area causes disturbance to the read element, thereby largely reducing an error rate of a read signal. In consideration thereof, JP-A-2002-230734 (Patent Document 1) is proposing to perform AC erase, in a servo area, to any area including no servo data, or an area between data and tracks.

With the SSW, for writing of servo patterns with accuracy, a technique is known to erase recording surfaces using a head element section, and to write a servo pattern to the erased area. Typically, with the SSW, an erase process and a servo pattern write process are repeated sequentially. With a magnetic disk of vertical magnetic recording, for user data access after HDD manufacturing, and for accurate head positioning with the SSW, it is desirable to perform servo pattern writing while the head element section is performing AC erase to the recording surfaces.

However, for AC erase with the SSW, resolution-required problems are found. One problem is that AC erase using the write element generates noise to a read signal of the read element. Other than this, if AC erase is continuously performed, there is a problem that a preamplifier IC will generate heat. Also, when AC erase is performed asynchronously, it is known that a frequency therefor is very important for the SSW or for product servo pattern reading with accuracy.

### BRIEF SUMMARY OF THE INVENTION

Embodiments in accordance with the present invention provide disk drives and methods to perform AC erase to a magnetic disk with good effects.

A data storage device of an embodiment of the present invention includes a disk including a data area for storage of user data, a head that makes access to the data area, and a mechanism that supports the head, and moves the head. The disk includes a servo area that stores servo data that is read to the head for positioning of the head, and includes a plurality of bursts, and an AC erase area that is subjected to AC erase asynchronously with a frequency three times or higher than a frequency of the bursts. In one embodiment, with AC erase performed asynchronously, because the frequency therefor is three times or higher than the burst frequency, the burst signal can be read with reliability. In one aspect, the AC erase area is subjected to AC erase by a frequency five times or higher than the frequency of bursts. The disk may include a plurality of bursts each with a space in the radius direction, where the space between the bursts is subjected to AC erase with the frequency three times or higher than the frequency of the bursts. In one aspect, this is because the area greatly affects a burst read signal.

Another embodiment of the present invention is directed to a method of writing a servo pattern on a recording surface of a rotating disk using a head including a read element and a write element disposed at each different position in the radius direction. With this method, the disk is rotated twice or more before the servo pattern on the recording surface is read by the read element. The write element is moved to an area not yet written with the servo pattern, a track is subjected to AC erase using the write element, and the write element is moved to a position of the track and then to another position of the track. Further, with this method, an area subjected to the AC erase is written with the servo pattern using the write element. This thus enables to suppress the heat generation of a circuit element for use for AC erase.

At the position of the track, the write element may perform AC erase on an intermittent basis. This accordingly suppresses the heat generation of the circuit element with good effects. In one embodiment, application of the positioning control is skipped using a part of the servo patterns, and in the duration of skipping, the write element performs the AC erase. This accordingly reduces noise generation to a read signal.

In another embodiment, the servo pattern plurally provided each with a space in the circumferential direction are read using the read element, and the write element is subjected to positioning at the position of the track. In a period of reading the servo pattern for control over the positioning, the AC erase by the write element is stopped. This favorably reduces noise generation to a read signal.

Still another embodiment of the present invention is directed to a method of writing a servo pattern on a recording surface of a rotating disk using a head including a read element and a write element disposed at each different position in the radius direction. With this method, the servo pattern on the recording surface is read by the read element, the write element is moved to an area not yet written with the servo pattern, the servo pattern provided plurally each with a space in the circumferential direction are read by the read element, the write element is positioned at a position of a track, at the positioned position of the track, AC erase is performed by the write element on an intermittent basis, and to an area subjected to the AC erase, the servo pattern is written by the write element. This accordingly enables suppression of the heat generation of a circuit element for use for AC erase.

At the position of the track, the AC erase may not be performed in the duration that the servo pattern is read for control over the positioning. This accordingly reduces noise generation to a read signal. In one embodiment, after the AC erase is started by the write element, the disk is rotated twice or less before the entire area is subjected to the AC erase at the position of the track. This favorably enables to reduce the processing time.

Still another embodiment of the invention is directed to a method of writing a servo pattern on a recording surface of a magnetic disk of vertical magnetic recording using a head including a read element and a write element. With this method, an area for use for measuring head characteristics is at least partially subjected to DC erase using the write element, the head characteristics are measured using a read signal of the read element in the area subjected to the DC erase, and after the head characteristics are measured, a process is repeated to perform AC erase using the write element, to write the servo pattern to an area subjected to the AC erase using the write element, and to position the head using the read signal of the read element of the servo pattern. This thus enables to measure the head characteristics in a preferable manner. For measurement of the head characteristics, the read element may read the base noise observed in the area having been subjected to the DC erase by the write element. This accordingly increases the base noise measurement values so that the yield reduction can be prevented.

According to the present invention, recording surfaces can be subjected to AC erase with good effects.

For a more complete understanding of embodiments in accordance with the present invention, reference is made to the following detailed description taken in conjunction with the accompanying drawings.

### BRIEF DESCRIPTION OF THE DRAWINGS

FIG. 1 is a diagram schematically showing the logical configuration of an HDA, and a servo write control device that exercises control over servo write of the HDA according to an embodiment of the present invention.

FIG. 2 is a diagram schematically showing the internal mechanism of the HDA according to an embodiment of the present invention.

FIG. 3 is showing a data format of a product servo pattern of a servo sector according to an embodiment of the present invention.

FIG. 4 is schematically showing a pattern to be written on a recording surface with an SSTW, and a writing method thereof according to an embodiment of the present invention.

FIG. 5 is schematically showing exemplary positioning of a read element at a target position, and exemplary writing of a pattern using a write element according to an embodiment of the present invention.

FIG. 6 is a diagram schematically showing an AC erase process in a servo pattern write sequence according to an embodiment of the present invention.

FIG. 7 is showing a signal spectrum of synchronous AC erase on a frequency axis, and a signal spectrum of asynchronous AC erase according to an embodiment of the present invention.

FIG. 8 is a diagram showing how a noise component is mixed into a reproduction signal with asynchronous AC erase of 2f and 5f according to an embodiment of the present invention.

FIG. 9 is showing a burst signal and a base noise signal with an AC erase frequency of 2f and 5f according to an embodiment of the present invention.

FIG. 10 is a diagram schematically showing the filter characteristics of an LPF according to an embodiment of the present invention.

FIG. 11 is showing a timing chart in a case where AC erase is performed for one track with two or less disk rotation according to an embodiment of the present invention.

FIG. 12 is showing a timing chart in a case where AC erase is performed for one track with four or less disk rotations according to an embodiment of the present invention.

### DETAILED DESCRIPTION OF THE INVENTION

Embodiments in accordance with the present invention relate to a method of servo pattern writing on a recording surface and a data storage device and, more specifically, to servo pattern writing onto a recording surface using a head including a read element and a write element.

Below are described particular embodiments to which the present invention is applicable. For explicit reference, the following description and the accompanying drawings are not fully made or entirely shown as appropriate. In the respective drawings, any similar component is provided with the same reference numeral, and for explicit reference, once-described matters are not described again as required. In one aspect, the following is a description of a servo write of a hard disk drive (HDD) being an example of a data storage device.

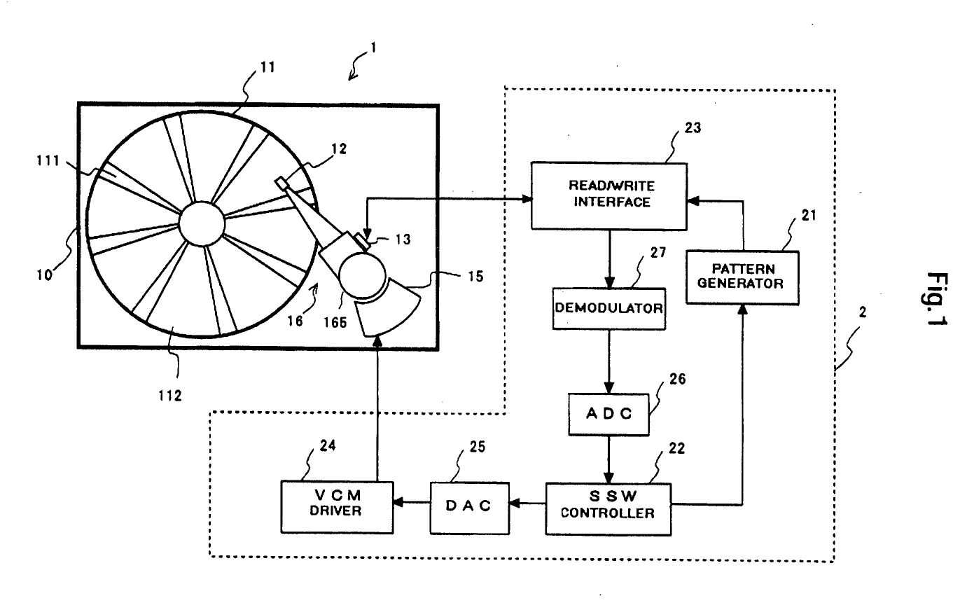

FIG. 1 is a block diagram schematically showing the logical configuration of an HDA 1, and a servo write control device 2 that exercises control over servo write of the HDA 1. The HDA 1 is a component of the HDD, and is provided with a cabinet 10 including a base and a top cover that closes the upper aperture of the base. The HDA 1 includes, in the cabinet, a magnetic disk 11 accommodated therein, a head slider 12, a preamplifier IC 13 being an exemplary circuit element, a voice coil motor (VCM) 15, and an actuator 16. The actuator 16 supports, at its tip end portion, the head slider 12. The preamplifier IC 13 is fixed to the actuator 16 via a circuit board (not shown), specifically, is fixed in the vicinity of a circular axis 161 thereof.

The HDD is also provided with, in addition to the HDA 1, a circuit board fixed to the outside of the cabinet 10. On the circuit board, an IC is incorporated for execution of signal processing and control processing. With servo write in this embodiment, the circuit on this circuit board for control use is not used, and the servo write control device 2 exercises control over servo write. With servo write in this embodiment, the internal mechanism of the HDA 1 is directly controlled, and the magnetic disk 11 is written with servo data (servo patterns). The magnetic disk 11 may be a nonvolatile storage disk that stores data by a magnetic layer being magnetized.

Such servo write is referred to as self servo write (SSW). With the SSW, using the components in the cabinet 10, the magnetic disk 11 is written with the servo data for use for writing and reading of user data. In the below, this servo data is referred to as product servo pattern. Note here that the servo write in an embodiment can be performed using the control circuit incorporated on the HDD.

The servo write control device 2 performs the SSW in one embodiment while exercising control thereover. The servo write control device 2 includes an SSW controller 22. This SSW controller 22 exercises control over the SSW in its entirety. The SSW controller 22 exercises control over positioning of the head slider 12, control over pattern generation, and others. The SSW controller 22 can be configured by a processor that operates in accordance with a micro code that is stored in advance. The SSW controller 22 executes control processing in accordance with a request coming from any external information processing device, and forwards any necessary information such as error information to the information processing device.

At the time of pattern writing to the magnetic disk 11, the SSW controller 22 issues a command to a pattern generator 21, and the pattern generator 21 generates any predetermined pattern. A read/write interface 23 goes through a conversion process for the pattern generated by the pattern generator 21, and forwards a pattern signal to the preamplifier IC 13. The preamplifier IC 13 amplifies the signal for transfer to the head slider 12, and the head slider 12 writes the pattern to the magnetic disk 11.

The SSW controller 22 exercises control over the actuator 16 using the signal read by the head slider 12, and moves and positions the head slider 12. To be specific, the signal read by the head slider 12 is input to a demodulator 27 via an RW interface 23. The read signal having been subjected to the demodulation process by the demodulator 27 is subjected to AD conversion by an AD converter 26, and the result is input to the SSW controller 22. The SSW controller 22 analyzes the resulting digital signal, and calculates a value control signal.

The SSW controller 22 forwards the value to a DA converter 25. The DA converter 25 subjects thus acquired data to DA conversion, and provides a control signal to a VCM driver 24. Based on the control signal, the VCM driver 24 supplies a control current to the VCM 15, and moves and positions the head slider 12. In this specification, the device including the components except for the servo write control device 2 and the magnetic disk 11 of the HDA 1 is referred to as self servo track writer (SSTW). That is, the SSTW takes charge of servo pattern writing onto the recording surface of the magnetic disk 11.

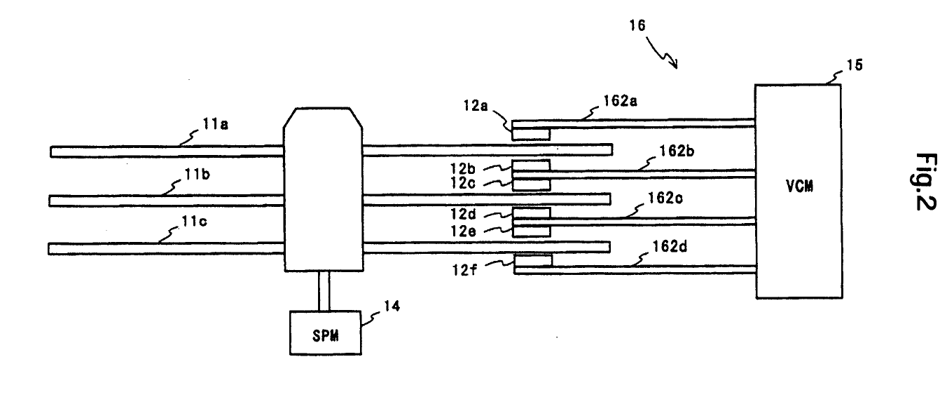

As shown in FIG. 2, the HDA 1 of this embodiment includes a plurality of magnetic disks 11a to 11c, and the magnetic disks 11a to 11c are respectively fixed to a rotation axis of a spindle motor (SPM) 14. The SPM 14 rotates the magnetic disks 11a to 11c fixed thereto with a predetermined angular speed. Moreover, both surfaces of the respective magnetic disks 11a to 11c are the recording surfaces, and the HDA 1 includes a plurality of head sliders 12a to 12f, respectively, corresponding to the recording surfaces.

The head sliders 12a to 12f are all fixed to the actuator 16. Specifically, an actuator arm 162a supports the head slider 12a, an actuator arm 162b supports the head sliders 12b and c, an actuator arm 162c supports the head sliders 12d and e, and an actuator arm 162d supports the head slider 12f.

The actuator 16 is coupled to the VCM 15, and rotates about the circular axis 161, thereby moving the head sliders 12a to 12f in the radius direction on the recording surfaces of the magnetic disks 11a to 11c. The head sliders 12a to 12f are each provided with a slider, and a head element section (not shown) serving as a thin film element formed thereto. The head element section is provided with a write element that converts an electric signal into a magnetic field in accordance with write data, and is also provided with a read element that converts the magnetic field from the magnetic disk 11 into an electric signal.

The preamplifier IC 13 selects any one head slider from the head sliders 12a to 12f for data reading, and amplifies (preamplifies) a reproduction signal reproduced by the selected head slider using a fixed gain. The result is output to the servo write control device 2. The preamplifier IC 13 amplifies the signal coming from the servo write control device 2, and outputs the result to the selected head slider. Typically, at the time of product servo pattern writing, all of the head sliders 12a to 12f are selected at the same time.

Referring back to FIG. 1, with the SSW, the magnetic disk 11 is formed with, on its recording surface, a plurality of servo areas 111 that extend radially from the center of the magnetic disk 11 in the radius direction, and are formed for every predetermined angle. FIG. 1 is exemplarily showing eight servo areas. The servo areas 111 are each recorded with a product servo pattern for positioning control over the head sliders at the time of reading/writing of user data. An area between any two adjacent servo areas 111 is a data area 112, and the user data is recorded thereonto. The servo areas 111 and the data areas 112 are disposed alternately for every predetermined angle.

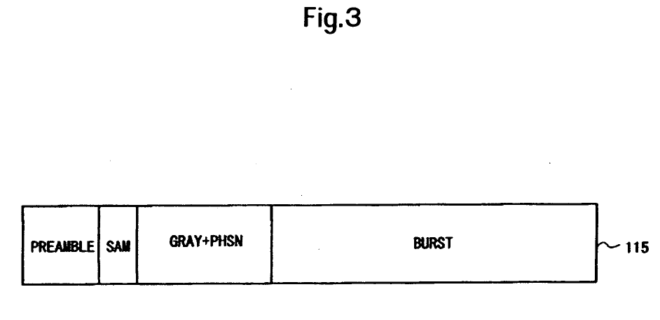

FIG. 3 shows a data format of a product servo pattern 115 of one servo sector. In one servo area 111, the product servo pattern 115 is formed for the servo sector in the circumferential direction, and in the radius direction, the product servo pattern 115 is formed for a plurality of servo sectors. The product servo pattern 115 is configured by a preamble (PREAMBLE), a servo address mark (SAM), a track ID being a gray code (GRAY), a servo sector number (PHSN) (optional), and a burst pattern (BURST). The SAM is a portion indicating where the actual information such as track ID begins, and has the precise correlation with the position on the magnetic disk 11 written with a SAM signal, which is a timing signal that is generally issued when the SAM is found.

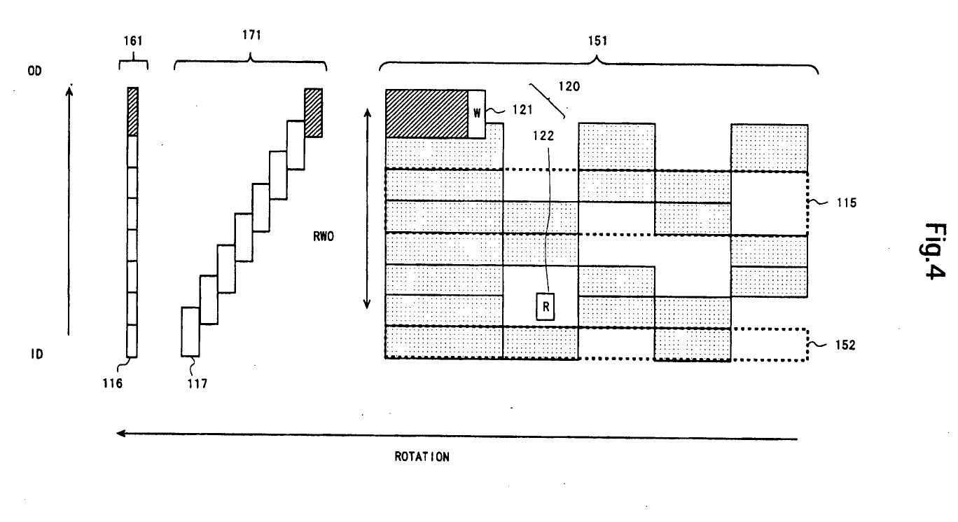

The burst pattern (BURST) is a signal that indicates the more precise position of the servo track indicated by the track ID. The burst pattern typically includes four amplitude signals of A, B, C, and D in a staggered format with a slight positional difference on an orbit for every servo track (refer to FIG. 4). These bursts are each a single frequency signal of the same cycle as the preamble (PREAMBLE).

FIG. 4 is schematically showing a pattern to be written onto the recording surface with the SSTW according to an embodiment of the present invention, and a method of writing the pattern. FIG. 4 is showing a pattern corresponding to one servo sector. The SSTW writes a timing pattern 116 and a radial pattern 117 in addition to the product servo pattern 115. The timing pattern 116 is a pulse pattern, and the radial pattern 117 is a burst of a predetermined frequency. Accordingly, one sector with the SSW in this embodiment includes an area 151 for writing of the product servo pattern 115, an area 161 for writing of the timing pattern 116 of one sector, and an area 171 for writing of the radial pattern 117 of one sector. The timing pattern 116 and the radial pattern 117 are written to the data area 112 that stores therein the user data.

With the SSTW, the pattern written for its own to the magnetic disk 11 is referred to, and using the temporal and spatial information derived from the signal, the next pattern is written to the position displaced by read/write offset (RWO) in the radius direction while the head element section 120 is being controlled temporally (timing control in the circumferential direction) and spatially (position control in the radius direction).

The read/write offset is a space in the head element section 120 in the radius direction between the write element 121 and the read element, and specifically, a distance between the center of the read element 122 and that of the write element 121 on the magnetic disk 11 in the radius direction. The read/write offset varies depending on the radial position on the magnetic disk 11. Note here that the write element 121 and the read element 122 show some position difference also in the circumferential direction, and the space in this direction is referred to as read/write separation.

With the SSTW in this embodiment, a selection is made from a plurality of head element sections 120 (e.g., the head element section of the head slider 12b in FIG. 2), and the selected head element section 120 is used to read the pattern on the recording surface. This head element section 120 is referred to as propagation head in this specification. With the SSTW, the signal read by the propagation head is used to exercise control over the actuator 16, and using all of the head sliders 12a to 12f, the pattern writing is performed simultaneously onto the respective recording surfaces.

In this embodiment, as shown in FIG. 4, the read element 122 is disposed on the side of the inner radius (ID) of the magnetic disk 11 compared with the write element 121. The pattern writing is performed from the inner radius side to the outer radius side. With pattern writing started from the inner radius side, the pattern previously written by the write element 121 can be read by the read element 122. This enables the write element 121 to perform any new pattern writing while positioning the head element section 120 using the pattern read by the read element 122. Note here that it is also possible to start the SSW from the outer side of the magnetic disk 11 by changing the positions of the write element 121 and the read element 122.

More specifically, with the SSTW, the head element section 120 is positioned using the radial pattern 116,117, and with the timing pattern 116 used as a reference, the timing is measured for pattern writing. Accordingly, the radial pattern 116, 117 is counted as one servo pattern for positioning control with the SSW. After a lapse of time predetermined by the timing at which the read element 122 of the propagation head reads the timing pattern, the write element 121 of each of the head element sections 120 writes the product servo pattern 115 (a part thereof). The timing pattern 116 for the next sector is written based on the reading of the timing pattern 116 of the preceding sector.

As shown in FIG. 4, the write element 121 writes the respective product servo patterns 115 in such a manner as to derive partial overlay in the radius direction. That is, for formation of the product servo patterns, the patterns are each partially written over the pattern on the outer radius side. FIG. 4 shows four already-written product servo patterns 115, and the write element 121 is in the process of forming another product servo pattern counted fifth from the inner radius side.

The write element 121 writes a half of the product servo pattern with a cycle of the magnetic disk. In this specification, the track corresponding to the half of the product servo pattern is referred to as a servo write track. The product servo pattern of one servo write track is denoted by 152. Moreover, the track of the product servo pattern is referred to as a servo track. The track pitch of the servo write track is a half of the servo track pitch. The example of FIG. 4 shows a case that seven servo write tracks are already written, and the write element 121 is in the process of writing another servo write track counted eighth from the inner radius side.

The timing pattern 117 in any one specific sector is formed at the position substantially the same in the circumferential direction. On the other hand, the radial patterns 117 are each formed at the position different from, in the circumferential direction, the radial pattern 117 adjacent thereto in the radius direction. That is, some position displacement is observed in the circumferential direction between any adjacent radial patterns 117. In the radius direction, some overlay is observed between any adjacent radial patterns 117. Note that, in FIG. 4, some sequential displacement is observed toward the right side of the drawing as the radial patterns 117 are directed to the outer radius direction, and in the track on the outer radius side, writing is performed to the position displaced toward the left side of the drawing.

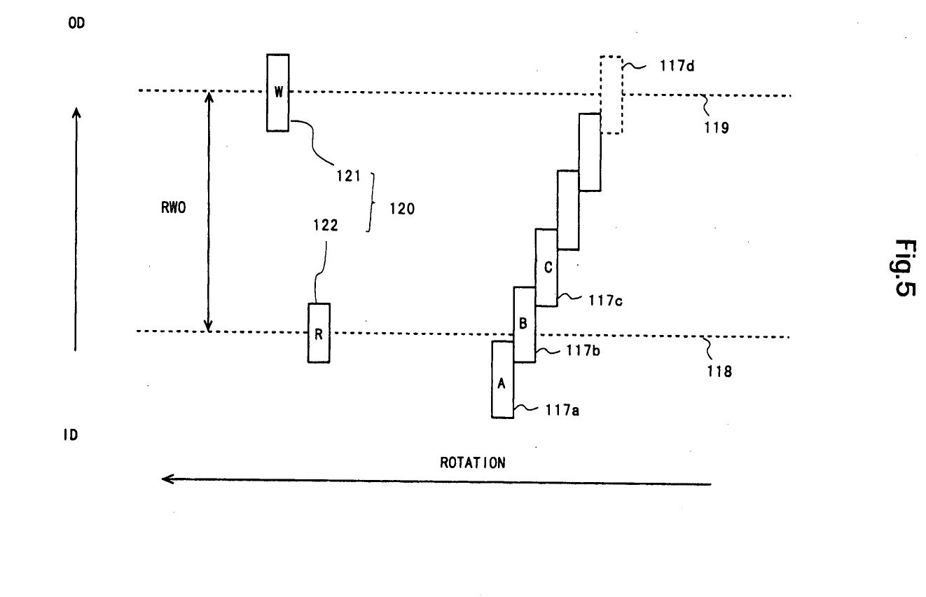

The SSW controller 22 performs head positioning using the read signal of the radial pattern 117. Specifically, by referring to FIG. 5, described is a case of positioning the read element 122 at a target position 118. In FIG. 5, in the radius direction, the dimension of the read element 122 corresponds to the read width, and the dimension of the write element 121 corresponds to the write width. The magnetic disk 11 rotates from right to left of the drawing, and the read element 122 moves from left to right of the drawing. The write element 121 writes the servo write track corresponding to the target position 119.

For positioning of the write element 121 at a target position 119, the SSW controller 22 moves the read element 122 from the target position 119 for positioning at the target position 118 located at an inner radius side of the read/write offset (RWO). The read element 122 reads radial patterns 117a, 117b, and 117c. The SSW controller 22 calculates a function value (in this specification, referred to as PES value) of the amplitudes (A, B, and C) of the respective radial patterns 117a, 117b, and 117c, and positions the read element 122 in such a manner that the value becomes the target value.

In the state that the read element 122 is positioned at the target position 118, the write element 122 writes the radial pattern 117d. Note that, in the pattern write process, typically, the target position of the read element 122 does not come to the center of the respective radial patterns 117, and is displaced in the radius direction.

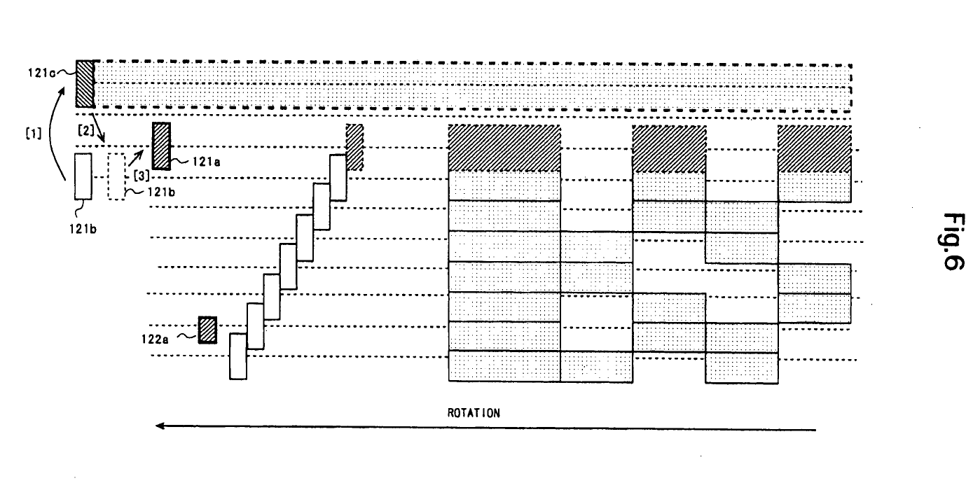

With the SSTW of this embodiment, in the servo pattern write sequence, an AC erase process is executed. In the AC erase process, a pattern of a predetermined frequency is written on the recording surface. This AC erase process is described by referring to FIG. 6. With the SSTW, a pattern write process including the product servo pattern 115 in the target servo write track (hereinafter, servo pattern write process) is repeated with the AC erase process at the position with a few servo write tracks away from the pattern-written position.

Specifically, by referring to FIG. 6, the write element 121 at a write element position 121b performs writing of a pattern including a product servo pattern at the target track. Thereafter, the write element 121 is moved to a write element position 121c with a few tracks away to the outer radius side from the current position [1]. The write element 121 performs AC erase at the servo write track being the movement destination. In the AC erase process, an AC erase pattern is written onto the recording surface, and an AC erase track is generated.

When the magnetic disk 11 is rotated once, and when the AC erase is completed for the track being the movement destination, the write element 121 is returned to the servo write track (write element position 121b) to which the pattern writing is performed immediately therebefore [2]. Moreover, the write element 121 is moved to the outwardly-adjacent servo write track for writing of a pattern including the next product servo pattern 115 [3], and at the write element position 121a, the pattern writing is performed. The read element position at this time is denoted by 121a.

Thereafter, with the SSTW, a seek process for any to-be-AC-erased servo write track, an AC erase process for the seeking destination, a seek process for position return before the seeking, another seek process for the outwardly-adjacent servo write track, and a servo pattern process for the seeking destination are repeated.

In one embodiment, the tracks are subjected to AC erase asynchronously. That is, no synchronization is observed in signals of the to-be-AC-erased tracks. This thus enables to perform the AC erase with the simple circuit configuration, having no need to establish synchronization for every track change. As such, with asynchronous AC erase, the frequency for use with the AC erase, i.e., the frequency of the AC erase pattern is preferably three times or higher than the burst frequency of a product servo pattern or the burst frequency of a radial pattern. More preferably, the AC erase frequency is five times or higher than the burst frequency of a product servo pattern or the burst frequency of a radial pattern. With such requirements satisfied, in the magnetic disk 11 of vertical magnetic recording, any adverse effects for pattern reading in to-be-AC-erased areas can be substantially prevented.

Described below is the above-described preferable AC erase frequency with an exemplary burst of a product servo pattern. Between the burst of the product servo pattern and a user data area, an AC erase area remains. With some SSW techniques, between bursts in a product servo pattern in the radius direction, an AC erase area remains as a base. This AC erase area affects reading of the product servo burst. Note here that the burst frequency of the product servo pattern and that of the radial pattern may take the same or different value.

The HDD subjects, to sampling, a product burst using a sample rate a few times higher than the burst frequency. For example, the HDD subjects, to sampling, a burst recorded with 60 MHz using an eight-time sample (8f=480 MHz), and parametrically performs signal demodulation by discrete Fourier transform. This realizes demodulation that is hardly affected by sudden temporal change of signals.

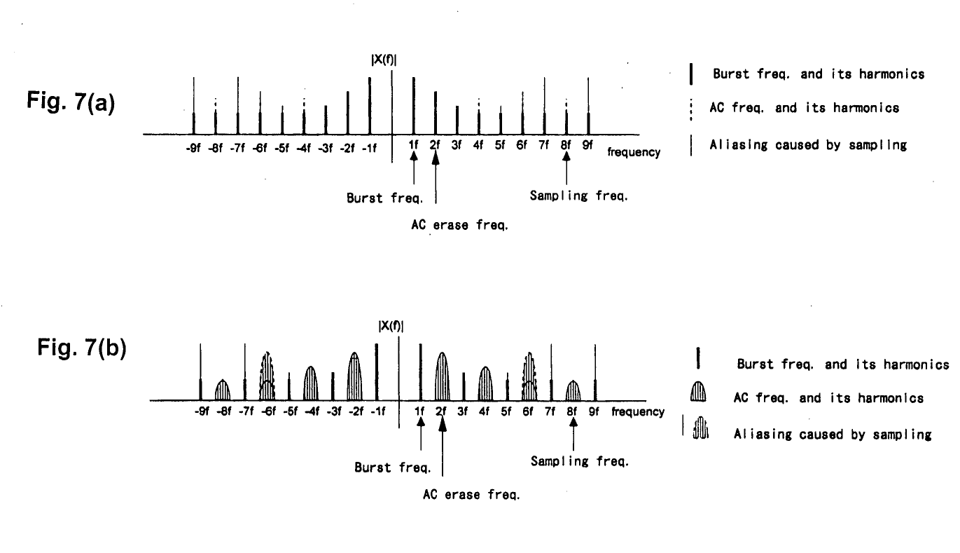

FIG. 7(a) shows a signal spectrum on a frequency axis of synchronous AC erase, and FIG. 7(b) shows a signal spectrum of asynchronous AC erase. Assumed here are that 1f denotes a burst frequency, 8f denotes a signal sampling frequency, and an AC erase frequency is 2f. The spectrum of the burst of 1f has harmonic contents of 2f, 3f, 4f . . . in addition to the basic component of 1f. At the time of reproduction, if reproduction is performed including the harmonic contents, no signal loss occurs. Moreover, at the time of sampling, a side band called alias (alias) is generated to the 8f sampling frequency and therearound, and this component is superposed on the 8f and therearound with a frequency being an integral multiple.

As shown in FIG. 7(a), with synchronous AC erase, the AC erase frequency component is superposed as to overlay the 2f component, and then the alias component of the 8f sampling frequency is also superposed on the 2f component. Accordingly, on the 2f component, in addition to the secondary harmonic contents of the original burst frequency, the basic component of the AC erase and their alias components are superposed. Because it is difficult to reproduce only any burst component therefrom, there needs to perform filtering, e.g., steep filter being free from Gibb's phenomenon, for example, 1.7f or more. This thus enables to demodulate only burst signals of 1f component (with signal loss only by harmonic content).

As shown in FIG. 7(b), with asynchronous AC erase, the AC erase frequency and its harmonic content, and an alias component by the 8f sampling exist with a width as shown in FIG. 7(b). In this case, in order to demodulate only bursts, there needs to be set lower the cut-off frequency (cut-off frequency: fc) of a low-pass filter (LPF), and any loss occurred to the basic components of the burst signal becomes larger than the case with the above-described synchronous AC erase.

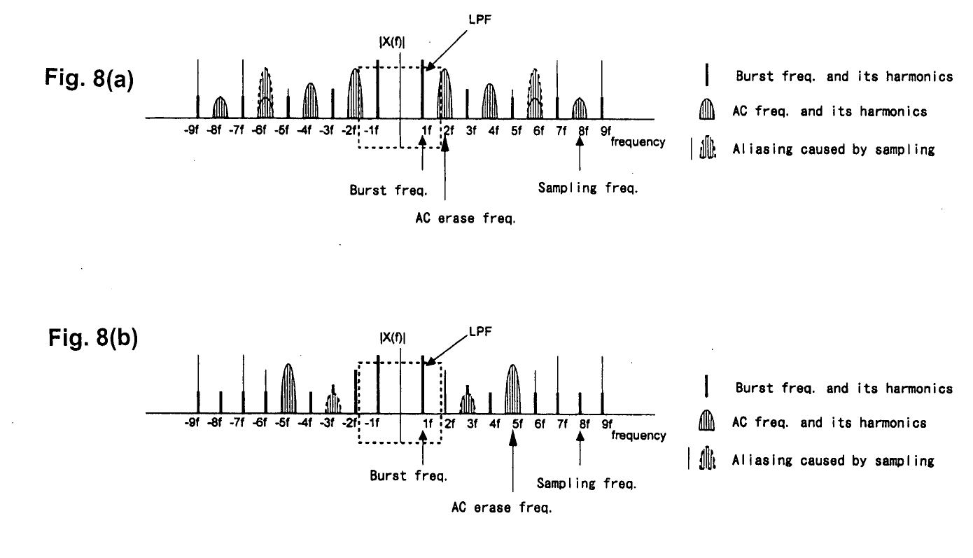

By referring to FIGS. 8(a) and (b), considered here are cases with asynchronous AC erase of 2f and 5f to see how a noise component is mixed to a reproduction signal. When filtering is performed with an LPF having the cut-off frequency fc=1.7f, as described above, some signal components are superposed on the adjacent 2f component. It is thus highly likely that the bottom part of the fluctuations of the 2f that is not cut by the LPF will mix as a reproduction signal. On the other hand, with asynchronous AC erase of 5f, at least on the 2f component, no superposition is observed with the AC component not including the secondary harmonic of the burst or its alias. Therefore, with the LPF of 1.7f, it is possible to prevent mixture of a noise component.

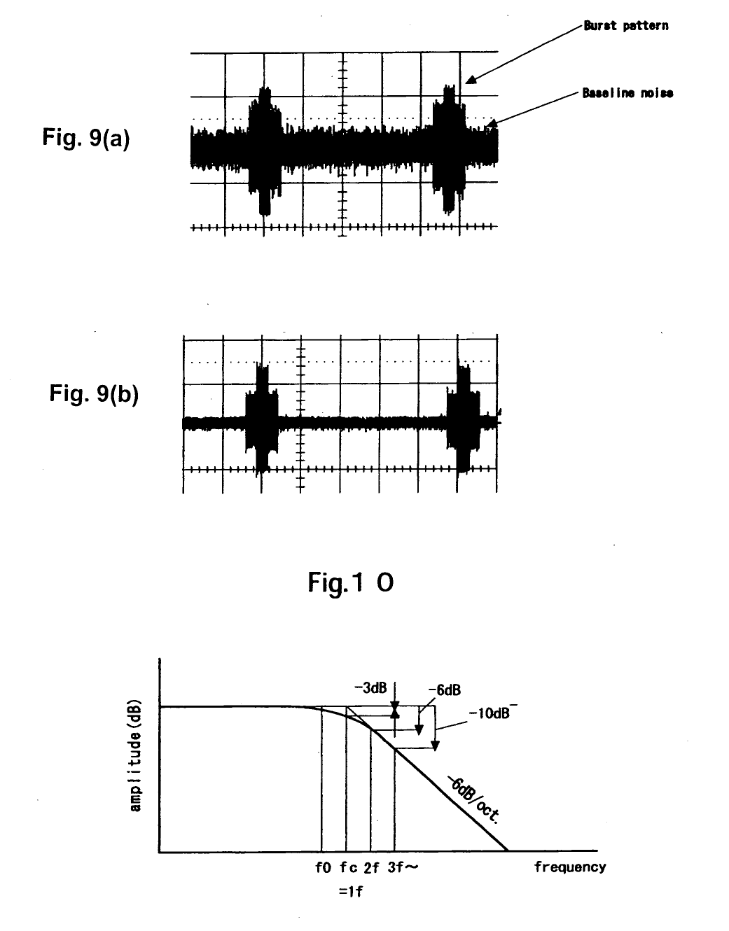

Actually, a burst signal of vertical magnetic recording is observed. FIG. 9(a) shows a burst signal and a base noise signal when the AC erase frequency is 2f. FIG. 9(b) shows a burst signal and a base noise signal when the AC erase frequency is 5f. Note here that, in the waveform for observation use, a signal reproduced by the head element section is subjected to differential operation for once. That is, a signal is filtered to a high-pass filter (HPF). The experiment result tells that, when the AC erase frequency is 2f, compared with the case with 5f, a base noise is larger in width. That is, the burst signal is low in S/N. This fact supports the cases considered above.

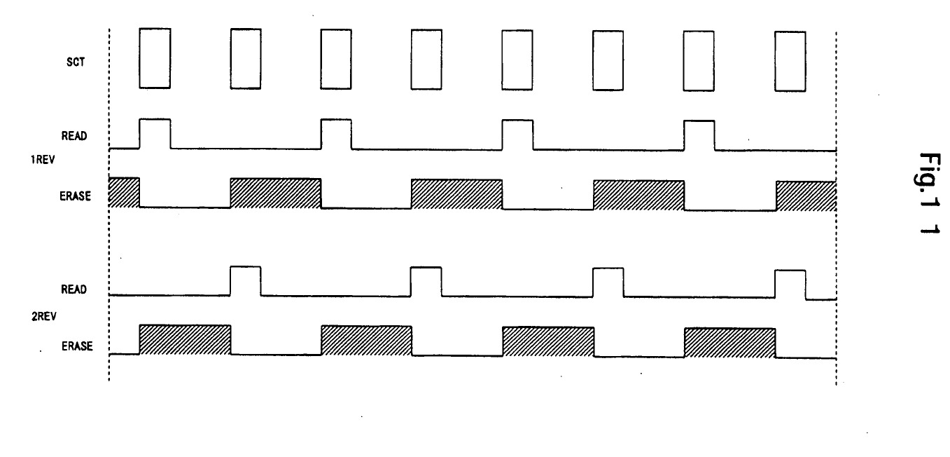

By referring to FIG. 10, considered here is a CR filter that is most typical as a circuit configuring an LPF. This filter shows the response reduction with the characteristics of −6 dB/oct. in an area of a frequency much higher than the cut-off frequency fc. If with a burst frequency of 1f=fc, the signal strength is ½ with 2f (fc), and ⅓ with 3f. On the other hand, also with 1f, a signal loss of 3 dB is already occurring compared with the amplitude of the original waveform. Assuming that the burst frequency is set to f0 that is lower than fc, 2f hardly causes signal deterioration. That is, it is difficult to perform filtering to the 2f frequency.

That is, in the vicinity of fc, a difference of about 3 dB is only possible between 1f and 2f, thereby not being able to keep the signal S/N. In view of signal reproduction, the signal S/N is required to be 6 dB or higher at the minimum, and if with consideration given to stability for fluctuations, required to be 10 dB or higher. If this is the case, the AC erase frequency is required to be 3f or higher. Further, as is understood from the description above, the AC erase frequency of 5f or higher is more preferable.

The above description is similarly applicable to the radial patterns with the SSW. At the time of writing of servo write track, for the burst signal of a radial pattern for use for positioning of the head element section 120, as described above, the frequency of AC erase being a base has preferably a value three times or higher, and more preferably, written is an AC erase pattern of the frequency five times or higher.

As described by referring to FIG. 6, with the SSTW of an embodiment, a seeking is performed to the head element section 120 on the outer radius side, and subjects any area not yet written with a pattern to AC erase. Herein, in order to subject any track being a movement destination to AC erase using the write element 121, there needs to use the read element 122 to read the radial pattern 117 on the inner radius side for servo control. The concern here is that, when the write element 121 writes an AC erase pattern, there may be cases that the read signal of the read element 122 is mixed with noise, the SSW controller 22 cannot exercise servo control with accuracy, and thus the write element 121 cannot be positioned at any target position.

In consideration thereof, with the SSTW of this embodiment, no AC erase is performed while the radial pattern 117 is being read for use for servo control. This thus prevents noise mixture to a radial pattern signal read by the read element 122. Moreover, because the target track is entirely subjected to AC erase, a plurality of disk rotations are utilized to perform AC erase for one track. For each disk rotation, the SSW controller 22 skips the radial pattern 117 for one or more sectors, and the read signal is not used for servo control. While the servo control is being skipped, the SSW controller 22 performs AC erase for any target area using the write element 121. The SSW controller 22 skips any different sector for every disk rotation, and subjects the different sectors to AC erase. This thus enables to perform AC erase to every area of the track.

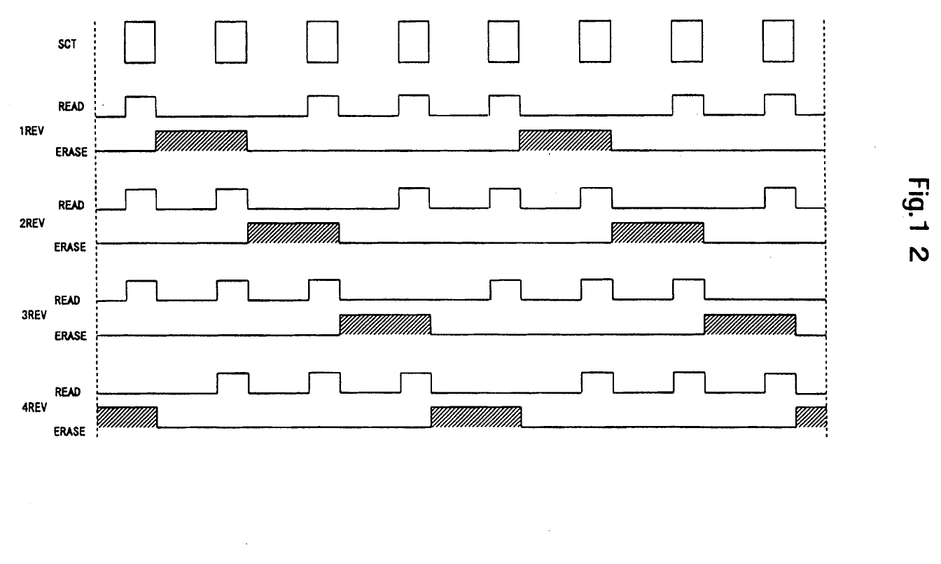

Specifically, by referring to FIG. 11, described is exemplary AC erase utilizing a plurality of disk rotations according to an embodiment of the present invention. FIG. 11 shows a timing chart in a case with AC erase for one track with two disk rotations. The SSW controller 22 exercises positioning control using a read signal of a radial pattern for every other sector. That is, the SSW controller 22 skips a control signal output to the VCM driver 24 for every two sectors. The magnetic disk 11 has a radial pattern of eight sectors (SCT) in the circumferential direction.

With the first rotation (1REV), the SSW controller 22 positions the head element section 120 using a read signal of each of the odd-numbered radial patterns of FIG. 11. While the read element 122 reading the odd-numbered radial patterns, the write element 121 performs no erase (ERASE). The SSW controller 22 skips the even-numbered radial patterns. In the meantime, the write element 122 writes the AC erase pattern onto the recording surface. With the first disk rotation, the write element 121 performs AC erase on an intermittent basis, and performs AC erase to an area equivalent to a half track.

With the second disk rotation (2REV), the SSW controller 22 positions the head element section 120 using a read signal of each of the even-numbered radial patterns. While the read element 122 reading such radial patterns, the write element 121 performs no erase (ERASE). The SSW controller 22 skips VCM control using the odd-numbered radial patterns. In the duration of skipping by the SSW controller 22, the write element 122 writes the AC erase pattern onto the recording surface. With the second rotation, the write element 121 performs AC erase on an intermittent basis, and performs AC erase to an area equivalent to a half of the track to which the AC erase is skipped for the first rotation.

As described above, the SSTW performs AC erase to the entire area of one track while the magnetic disk 11 rotates twice. While the read element 122 reads the radial pattern for use for servo control, the AC erase by the write element 121 is skipped so that the head positioning is performed with accuracy. Moreover, by the SSW controller 22 skipping different sectors or sector groups depending on the disk rotation, the area to be subjected to AC erase will be different for every rotation. This enables to subject every area of one track to AC erase. Note here that the sectors may be each defined as an area including not only a radial pattern but also a timing pattern or a product servo pattern. Herein, if the AC erase is completed before the second rotation is fully through, there is no need to wait for the second rotation to be completed for moving the write element 121 to any other position. Herein, with erasing with such skipping, only the sector from which the read element 122 reads a radial pattern is subjected to positioning control so that the radial pattern sampling (reading) is performed less often for positioning control. It is thus desirable to switch to a VCM control system adopting to the sampling. These are applicable to the following description.

FIG. 12 is a timing chart in a case where the AC erase is performed for one track with four disk rotations. Similarly to the example of FIG. 11, the magnetic disk 11 includes a radial pattern of eight sectors (SCT) in the circumferential direction. As shown in FIG. 12, the SSW controller 22 skips the second and sixth sectors with the first disk rotation, skips the third and seventh sectors with the second disk rotation, skips the fourth and eighth sectors with the third disk rotation, and skips the first and fifth sectors with the fourth disk rotation.

The write element 121 performs AC erase to an area (period) corresponding to any skipped sector for every disk rotation. In FIG. 12 example, for every disk rotation, the write element 121 performs AC erase to the same area, and no superposition is observed between areas to be subjected to AC erase with each disk rotation. That is, the write element 121 performs AC erase to not-yet-AC-erased area for every rotation.

In view of the servo write processing time, with the SSTW, an AC erase may be completed for one track with two disk rotations. However, AC erase not only affects servo control but also causes a problem of heat generation of the preamplifier IC 13. That is, in the process of AC erase, the preamplifier IC 13 successively outputs a high-frequency signal, thereby consuming a large amount of power, and increasing the amount of heat generation. Therefore, if the AC erase continues too long, this causes errors due to the high heat with the operation of the preamplifier IC 13. Other than this, the element inside of the preamplifier IC 13 may be possibly suffered from heat damage.

Accordingly, in view of heat generation of the preamplifier IC 13, in one embodiment, an AC erase is performed for one track with a longer time for heat dissipation or for others as long as possible. That is, with FIG. 12 example, an AC erase is performed for one track with two or more disk rotations. What is more, in view of controlling heat generation, it is preferable to perform AC erase to the same area for every disk rotation of the magnetic disk 11, and for every disk rotation, areas being away from each other in the circumferential direction are subjected to AC erase so that the successive output time is preferably reduced for the preamplifier IC 13.

In the above-described preferable embodiment, a track is subjected to AC erase on an intermittent basis. Other than this, when a plurality of tracks are subjected to AC erase in any sought area on the outer radius side in the pattern write process, an AC erase may be performed to each of the tracks on an intermittent basis. For example, when any specific servo write track is through with pattern writing, the SSW controller 22 seeks the write element 121 to the area on the outer radius side.

With one or more disk rotations, after one track is subjected to AC erase for one track, the SSW controller 22 moves the write element 121 to the position of a track on the outer radius side, and performs AC erase to the area. At this time, before the seek operation is started, or after the write element 121 is moved to any target position, the SSW controller 22 waits, as an interval, for one or more disk rotations. That is, the write element 121 is moved to any specific track position (after it reached the track position), and after AC erase is performed, two or more disk rotations are used until the write element 121 is moved from the track position to any other position. The movement destination is any other track position for AC erase, or the track position for writing of a servo pattern on the inner radius side.

As such, in the state that the write element 121 is positioned at any specific track position, the SSW controller 22 waits for the time to pass without performing writing. With such an interval, the preamplifier IC 13 can be reduced in temperature.

With the SSTW, in an area on the outer radius side, three or more tracks may be subjected to AC erase. Also in this case, an interval is preferably provided while the tracks are being subjected to AC erase. The period of an interval is preferably one or more disk rotations, however, any appropriate time can be set to the preamplifier IC 13 depending on designing.

With the SSW, before writing of a product servo pattern is started, there is an initial sequence for measuring the head characteristics. As is known from the description made referring to FIGS. 4 and 5, with the SSW, pattern writing is performed utilizing the characteristics of the head element section 120, e.g., read/write offset or write width. To be specific, the write width defines the track pitch, and the read/write offset defines the distance between a read track and a write track.

As such, it is important to accurately specify a characteristic value for the head element section 120 in the initial sequence for the SSW. Specifically, in the initial sequence, the measurement is performed not only to the write width and the read/write offset but also to the base noise. Herein, the characteristic value of the head element section 12 varies depending on the HDD so that there needs to perform the measurement for every HDD. The SSW controller 22 exercises control over the sequence for execution.

Typically, the head characteristics measurement is performed in the state that the actuator 16 is pressed to a crash stop (not shown). The crash stop is a member that restricts the movement in the circular direction by crash with the actuator 16, and is disposed to both the inner radius side and the outer radius side with respect to the actuator. The measurement of the write width and the read/write offset is performed by erasing a specific area using the write element 121, and to the erased area, a burst pattern is written by the write element 121. Thereafter, using a signal derived by reading the written burst pattern by the read element 122, the write width and the read/write offset are defined.

The measurement of the base noise is performed by erasing one track using the write element 121, and the erased track is read by the read element 122. The base noise is used to determine the amplitude of the read signal thereafter. Specifically, the measurement is repeated for a plurality number of times, and using the resulting average value, the base noise is used for writing of the product servo pattern thereafter. Note here that the measurement of the head characteristics is a well-known technique, and thus is not described in detail.

In one embodiment, in this initial sequence, the area for use for the head measurement is not subjected to AC erase but to DC erase. With the DC erase, the magnetic layer of the recording surface is magnetized in one direction. It is important to subject especially the area for use for measurement of the base noise to DC erase. This is because the AC-erased area shows the larger base noise than the DC-erased area. The SSW controller 22 defines a signal threshold value from the specified base noise. For the read signal, the SSW controller 22 uses the threshold value to determine the actual signal strength. Therefore, when the base noise is large in value, the margin from the threshold value becomes small, and as a result, the yield is reduced for the SSW. In consideration thereof, in one aspect, the measurement of the base noise is performed by reading the DC-erased area using the write element 121.

As such, the present invention is described with an exemplary preferable embodiment, but the present invention is not restrictive to the above-described embodiment. Those skilled in the art can device modifications, additions, and variations for the components of the above-described embodiment without departing from the scope of the present invention with ease. For example, the present invention is applicable not only to HDDs but also to other types of data storage device. The servo write control device 2 of the embodiment is not the HDD, but a servo write control function can be provided to the control circuit of an HDD. The frequency for use with AC erase can be applicable not only to SSW but also to a case of performing AC erase. Thus, although the present invention has been described with respect to specific embodiments, it will be appreciated that the present invention is intended to cover all modifications and equivalents within the scope of the following claims.

What is claimed is:

1. A data storage device, comprising
a disk including a data area for storage of user data;
a head that makes access to the data area; and
a mechanism that supports the head, and moves the head, wherein
the disk includes:
a servo area that stores servo data that is read to the head for positioning of the head, and includes a plurality of bursts; and
an AC erase area that is subjected to AC erase asynchronously with a frequency three times or higher than a frequency of the bursts.

2. The data storage device according to claim 1, wherein
the disk includes the plurality of bursts each with a space in a radius direction, and the space between the bursts is subjected to the AC erase with the frequency three times or higher than the frequency of the bursts.

3. The data storage device according to claim 1, wherein
the AC erase area is subjected to the AC erase with a frequency five times or higher than the frequency of the bursts.

4. A method of writing a servo pattern on a recording surface of a rotating disk using a head including a read element and a write element disposed at each different position in a radius direction, wherein
the disk is rotated twice or more before the servo pattern on the recording surface is read by the read element and the write element is moved to an area not yet written with the servo pattern, a track is subjected to AC erase using the write element, and the write element is moved to a position of the track and then to another position of the track, and
an area subjected to the AC erase is written with the servo pattern using the write element.

5. The method according to claim 4, wherein
at the position of the track, the AC erase is performed by the write element on an intermittent basis.

6. The method according to claim 4, wherein
the servo pattern plurally provided each with a space in a circumferential direction are read using the read element, and the write element is subjected to positioning at the position of the track, and
in a period of reading the servo patterns for control over the positioning, the AC erase by the write element is stopped.

7. The method according to claim 5, wherein
the control over the positioning using a part of the servo patterns is skipped, and in a duration of skipping, the AC erase is performed using the write element.

8. A method of writing a servo pattern on a recording surface of a rotating disk using a head including a read element and a write element disposed at each different position in a radius direction, wherein
the servo pattern on the recording surface is read by the read element, and the write element is moved to an area not yet written with the servo pattern,
the servo pattern plurally provided each with a space in a circumferential direction are read by the read element, and the write element is positioned at a position of a track,
at the positioned position of the track, AC erase is performed by the write element on an intermittent basis, and
to an area subjected to the AC erase, the servo patterns are written using the write element.

9. The method according to claim 8, wherein
at the position of the track, the AC erase is stopped while the servo pattern is read for control over the positioning.

10. The method according to claim 9, wherein
after the AC erase is started by the write element, the disk is rotated twice or less before an entire area is subjected to the AC erase at the position of the track.

11. The method according to claim 8, wherein
the AC erase is asynchronously performed, and a frequency for the AC erase is three times or higher than a frequency of a burst included in the servo pattern.

12. A method of writing a servo pattern on a recording surface of a magnetic disk of vertical magnetic recording using a head including a read element and a write element, wherein
an area for use for measuring head characteristics is at least partially subjected to DC erase using the write element,
the head characteristics are measured using a read signal of the read element in the area subjected to DC erase, and
after the head characteristics are measured, a process is repeated to perform AC erase using the write element, to write the servo pattern using the write element to an area subjected to the AC erase, and to position the head using the read signal of the read element of the servo pattern.

13. The method according to claim 12, wherein
the head characteristics are measured, using the read element, by reading a base noise of the area subjected to the DC erase using the write element.
